(19) United States
(12) Patent Application Publication
(10) Pub. No.: US 2025/0016620 A1
(43) Pub. Date: Jan. 9, 2025

(54) SERVICE INSTANCES, SCHEDULER NODE AND METHODS FOR HANDLING LOAD BALANCING IN A COMMUNICATIONS NETWORK

(71) Applicant: Telefonaktiebolaget LM Ericsson (publ), Stockholm (SE)

(72) Inventors: Michal WOSKO, Krakow (PL); Dan Gren, Upplands Väsby (SE)

(21) Appl. No.: 18/708,896

(22) PCT Filed: Nov. 10, 2021
(86) PCT No.: PCT/EP2021/081217

§ 371 Date: May 9, 2024

(51) Int. Cl. H04W 28/08

(52) U.S. Cl. CPC H04W 28/08

(57) ABSTRACT

A method performed by a first service instance for handling Load Balancing (LB) is provided. The LB is for a workflow transmitted between a first peer and a second peer via a chain of service instances in a communications network. The first service instance receives a request data from the first peer. The first service instance obtains from a scheduler, a set of allocation options for LB of the workflow, computed based on the request data. The first service instance decides based on considering the set of allocation options, a next, a second service instance in the chain of service instances, for the LB. The first service instance sends to the decided second service instance, the obtained set of allocation options. This in turn enables a third service instance at an appropriate step of executing the workflow, to consider the set of allocation options, for deciding if any remains, a further next fourth service instance for the LB.

### TECHNICAL FIELD

Embodiments herein relate to a first service instance, a second service instance, a scheduler and methods therein. In some aspects, they relate to handling Load Balancing (LB). The LB is done for a workflow transmitted between a first peer and a second peer via a chain of service instances in a communications network.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specifying the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range, referred to as Millimeter wave (mmWave), have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### Microservice Architecture

Microservice architecture also referred to as Microservices, is an architectural paradigm in which a single application is composed of many loosely coupled and independently deployable smaller components, each performing a single function, also referred to as service instances. This paradigm is featured prominently in cloud native approaches.

One of several advantages of a microservice architecture is the relative ease of performing scaling, particularly horizontal scaling, to reflect changing needs in terms of workload. The process of distributing the workload is referred to as Load Balancing, LB. In general, when there are multiple instances of a service type, a request associated with a service type is forwarded to one of the available instances of that type. There are different patterns and algorithms which influence how this forwarding happens. In particular, LB may be centralized or distributed in terms of the information used and decision-making; it may be done on the client side, the server side or both; it may be static, i.e., following fixed rules, or dynamic, when taking into account the current state of the system, e.g., the known load of the single instances.

Commonly, load balancers, i.e., processing units, used in microservice-based networks, independently of their location and the algorithm employed, make a local decision to which instance an incoming request is to be forwarded next. In a typical scenario, for a request coming from an external client, at the server side a Service Backend (BE) instance is chosen to process it. If the BE can provide the response on its own, that response is returned to the client, but if additional calls to other services are necessary, LB is triggered again to pick the instances which will continue processing.

### SUMMARY

As part of developing embodiments herein, the inventors identified a problem that first will be discussed.

There are systems implemented according to the microservice architectural paradigm which must satisfy non-functional requirements, e.g. constraints and optimization objectives, over a whole workflow execution, whether these are defined for all workflow instances processed or a statistic measure over them. Such non-functional requirements are also often time-sensitive, e.g., concerning latency or total request processing time, which means that ideally no latency should be introduced as a side effect of managing the processing. In addition, a system like the virtualized radio access network (VRAN) typically executes workflows of a known structure, spanning multiple service instances of likewise known types.

Even if an original request is part of a well-known sequence of calls to specific service types, or an otherwise structured task graph, or workflow, in existing LB methods for microservices, all the LB decisions are taken only for the next step. Thus, the existing LB methods may take into consideration the current state of the system, e.g., instance load, but not the non-functional requirements for the whole, or remaining, workflow execution span, which the system operator may be interested in upkeeping, e.g., total response time.

This deferred decision, one-step look-ahead approach has advantages in some specific problem settings. Firstly, no additional complexity is introduced when the workflows to be processed are either very small in terms of the task graph size, number of services involved, or very variable, where little information on the static workflow structure can be exploited. It is also a reasonably working strategy when there are no explicit non-functional requirements. Secondly, local decision making means no information driving LB decisions needs to be retrieved during the process from elsewhere in the system. Similar considerations apply to client-side LB.

VRANs are a way for telecommunications operators to run their baseband functions as software. This is achieved by applying principles of virtualization to the RAN, and it may be one part of a larger Network Function Virtualization (NFV) effort.

In a system such as a VRAN, however, there are known workflows spanning over specific types of microservice-based implementations of network functions. Commonly, the execution of such workflows is also subject to non-functional requirements defined over their whole span.

There are microservice-based environments, such as VRAN deployments, where known workflows spanning multiple service instances, of likewise known types are enacted. Each enactment may be subject to known constraints, like Service Level Agreements (SLAs) and/or optimization objectives, some of which are sensitive to execution time. Note that, conversely, not all instances of all workflows running in a system are time-sensitive and an efficient method of managing the system may consider such different requirements.

As pointed out above, in such settings it is possible to attempt to optimize the workflow execution by using the global information on its requirements and the known, static workflow structure, but existing LB methods, by design, do not take advantage of such knowledge. Instead, in most practical settings, such decisions are made locally in a sub-optimal way, either by applying simple criteria, e.g., choosing the instance of a service with the least known load, or even using trivial uninformed algorithms, such as round-robin.

A problem with the one-step look-ahead approach in such systems is that it cannot adequately process constraints and optimization objectives which are frequently defined for the whole execution span of a workflow, or a statistical measure over many executions of one or many workflows. Under the presence of non-trivial global constraints and objectives, local decisions cannot guide the search for a globally optimal, or near-optimal solution, thus the system may provide a sub-optimal performance. In other scenarios, local decisions may still achieve global near-optimality but do so by unnecessarily striving for local optimality at single each step, i.e., providing inefficient solutions

An object of embodiments herein is to provide an improved way of handling LB in a communications network.

According to an aspect of embodiments herein, the object is achieved by a method performed by a first service instance for handling LB. The LB is for a workflow transmitted between a first peer and a second peer via a chain of service instances in a communications network.

The first service instance receives a request data from the first peer. The which request data indicating a type of the workflow and quality of service (QOS) requirements for the workflow.

The first service instance obtains from a scheduler, a set of allocation options for LB of the workflow, computed based on the request data. Each allocation option in the set of allocation options, identifies a respective associated service instance out of the chain of service instances, to consider for an upcoming LB decision at an appropriate step of executing a part of the workflow, wherein the chain of service instances comprises at least the first service instance, a second service instance and a third service instance.

The first service instance decides based on considering the set of allocation options, a next, a second service instance in the chain of service instances, for the LB.

The first service instance sends to the decided second service instance, the obtained set of allocation options. This enables the second service instance at an appropriate step of executing the workflow, to consider the set of allocation options, for deciding a next, a third service instance for the LB, and to forward the set of allocation options to the decided third service instance. This in turn enables the third service instance at an appropriate step of executing the workflow, to consider the set of allocation options, for deciding if any remains, a further next fourth service instance for the LB.

According to another aspect of embodiments herein, the object is achieved by method performed by a second service instance for handling Load Balancing, LB. The LB is for a workflow transmitted between a first peer and a second peer via a chain of service instances in a communications network.

The second service instance receives from the first service instance in the chain of service instances, a set of allocation options for LB of the workflow. Each allocation option in the set of allocation options, identifies a respective associated service instance out of the chain of service instances, to consider for an upcoming LB decision at an appropriate step of executing a part of the workflow. The chain of service instances comprises at least a first service instance, the second service instance and a third service instance.

At an appropriate step of executing the workflow, the second service instance decides a next, a third service instance for the LB, based on considering the set of allocation options.

The second service instance sends to the decided third service instance, the set of allocation options. This enables the third service instance at an appropriate step of executing the workflow, to consider the set of allocation options, for deciding if any remains, a further next, a fourth service instance for the LB.

According to an aspect of embodiments herein, the object is achieved by a method performed by a scheduler for handling Load Balancing, LB. The LB is for a workflow transmitted between a first peer and a second peer via a chain of service instances in a communications network.

The scheduler receives from the first instance, a request data, which request data indicates a type of the workflow and quality of service, QoS, requirements for the workflow.

The scheduler then computes a set of allocation options for LB of the workflow based on the request data. Each allocation option in the set of allocation options, identifies a respective associated service instance out of the chain of service instances, to consider for an upcoming LB decision at an appropriate step of executing a part of the workflow. The chain of service instances comprises at least the first service instance, a second service instance and a third service instance.

The scheduler sends the computed set of allocation options for LB of the workflow to the first instance. This enables the first instance to decide, based on considering the set of allocation options, a next, a second service instance in the chain of service instances, for the LB. Further, to send the obtained set of allocation options to the decided second service instance.

This in turn enables the second service instance at an appropriate step of executing the workflow, to consider the set of allocation options, for deciding a next, a third service instance for the LB, and to forward the set of allocation options to the decided third service instance. This in turn enables the third service instance at an appropriate step of executing the workflow, to consider the set of allocation options, for deciding if any remains, a further next fourth service instance for the LB.

According to another aspect of embodiments herein, the object is achieved by a first service instance configured to handle Load Balancing, LB. The LB is adapted for a workflow to be transmitted between a first peer and a second peer via a chain of service instances in a communications network. The first service instance is further configured to:
Receive a request data from the first peer, which request data is adapted to indicate a type of the workflow and quality of service (QOS) requirements for the workflow,
obtain from a scheduler a set of allocation options for LB of the workflow, computed based on the request data, where each allocation option in the set of allocation options, is adapted to identify a respective associated service instance out of the chain of service instances, to consider for an upcoming LB decision at an appropriate step of executing a part of the workflow, wherein the chain of service instances is adapted to comprise at least the first service instance, a second service instance and a third service instance,
decide based on considering the set of allocation options, a next, a second service instance in the chain of service instances, for the LB,
send to the decided second service instance, the obtained set of allocation options, enabling the second service instance at an appropriate step of executing the workflow, to consider the set of allocation options, for deciding a next, a third service instance for the LB, and to forward the set of allocation options to the decided third service instance, to enable the third service instance at an appropriate step of executing the workflow, to consider the set of allocation options, for deciding if any remains, a further next fourth service instance for the LB.

According to an aspect of embodiments herein, the object is achieved by a second service instance configured to handle Load Balancing, LB. The LB is adapted for a workflow to be transmitted between a first peer and a second peer via a chain of service instances in a communications network. The second service instance is further configured to:
Receive from the first service instance in the chain of service instances, a set of allocation options for LB of the workflow, where each allocation option in the set of allocation options, is adapted to identify a respective associated service instance out of the chain of service instances, to consider for an upcoming LB decision at an appropriate step of executing a part of the workflow, wherein the chain of service instances is adapted to comprise at least a first service instance, the second service instance and a third service instance
at an appropriate step of executing the workflow, decide a next, a third service instance for the LB, based on considering the set of allocation options, and
send to the decided third service instance, the set of allocation options, enabling the third service instance at an appropriate step of executing the workflow, to consider the set of allocation options, for deciding if any remains, a further next, a fourth service instance for the LB.

According to another aspect of embodiments herein, the object is achieved by a scheduler configured to handle Load Balancing, LB. The LB is adapted for a workflow to be transmitted between a first peer and a second peer via a chain of service instances in a communications network. The scheduler is further configured to:
Receive from the first instance, a request data, which request data is adapted to indicate a type of the workflow and quality of service (QOS) requirements for the workflow,
compute a set of allocation options for LB of the workflow based on the request data, where each allocation option in the set of allocation options, is adapted to identify a respective associated service instance out of the chain of service instances, to consider for an upcoming LB decision at an appropriate step of executing a part of the workflow, wherein the chain of service instances is adapted to comprise at least the first service instance, a second service instance and a third service instance,
send the computed set of allocation options for LB of the workflow to the first instance, enabling the first instance to decide, based on considering the set of allocation options, a next, a second service instance in the chain of service instances, for the LB, and to send to the decided second service instance, the obtained set of allocation options. This enables the second service instance at an appropriate step of executing the workflow, to consider the set of allocation options, for deciding a next, a third service instance for the LB, and to forward the set of allocation options to the decided third service instance. This in turn enables the third service instance at an appropriate step of executing the workflow, to consider the set of allocation options, for deciding if any remains, a further next fourth service instance for the LB.

Due to the fact that the set of allocation options is forwarded by each of the service instances in the chain along with the request, the service instance the request is forwarded to is capable of considering the set of allocation options, for deciding a next service instance for the LB, without needing to fetch any information needed to make its local LB decision, when required, from any central control entity. Therefore, time for LB decision is short and efficient and unnecessary delay is avoided. In this way, embodiments herein provide an improved way of handling LB in a communications network.

### BRIEF DESCRIPTION OF THE DRAWINGS

Examples of embodiments herein are described in more detail with reference to attached drawings in which:

FIG. 1 is a schematic block diagram illustrating embodiments of a communications network.

FIG. 2 is a flowchart depicting an embodiment of a method in a second service instance.

FIG. 3 is a flowchart depicting an embodiment of a method in a scheduler.

FIG. 4 is a flowchart depicting an embodiment of a method in a first service instance.

FIGS. 5a-b are schematic block diagrams illustrating embodiments of a communications network.

FIG. 6a-b are schematic block diagrams illustrating embodiments of a VRAN.

FIG. 7a-b are schematic block diagrams illustrating embodiments of a first service instance.

FIG. 8a-b are schematic block diagrams illustrating embodiments of a second service instance.

FIG. 9a-b are schematic block diagrams illustrating embodiments of a scheduler.

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12-15 are flowcharts illustrating methods implemented in a communication system including a host computer, a base station and a user equipment.

### DETAILED DESCRIPTION

According to some examples, embodiments herein are related to in-band load balancing of workflows over compositions of service instances, such as microservices.

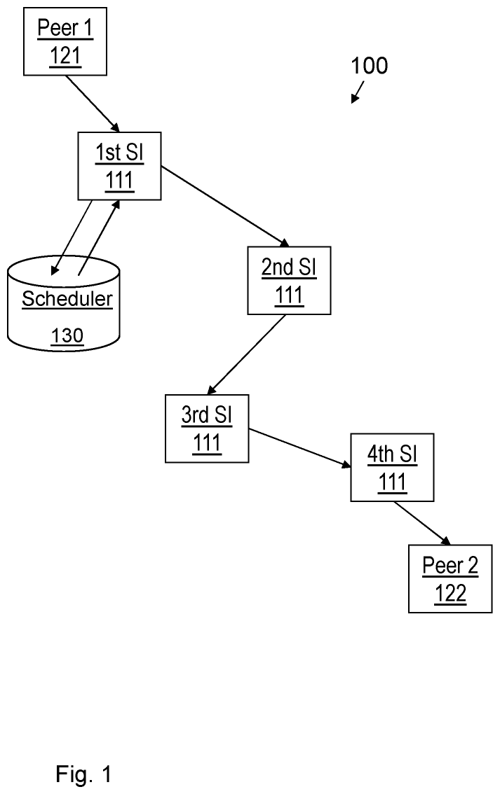

FIG. 1 is a schematic overview depicting a communications network 100 wherein embodiments herein may be implemented. The communications network 100 may e.g. be a microservice-based system, or a VRAN. The communications network 100 may use a number of different technologies, such as mmWave communication networks, Wi-Fi, Long Term Evolution (LTE), LTE-Advanced, 5G, 6G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G or 6G context, however, embodiments are also applicable in further development of the existing wireless communication systems such as e.g. WCDMA and LTE.

The communications network 100 may be a distributed system composed of a few pools of services of different types, also referred to as service instances, connected by transport links. Thus number of service instances operate in the communications network 100 such as e.g., a first service instance 111 also referred to as a first service instance unit 111, a second service instance 112, also referred to as a second service instance unit 112, a third service instance 113, also referred to as a third service instance unit 113, and a fourth service instance 114, also referred to as a fourth service instance unit 114.

The service instances 111, 112, 113, 114 may be service instances within a pool of services or control functions, e.g., Cell Control Functions (CellF) s, e.g., within a pool of services, UE Control Functions (UEF) s, Packet Processing Functions (PPF) s e.g. within a pool of services, User Plane Control Functions (UPCF) s.

The service instances 111, 112, 113, 114 may e.g. also be regarded as load balancers, i.e. service instances performing LB. They may be regarded as load balancers as they make the final LB decisions in addition to their regular processing of the request.

A number of end points, e.g. peers, operate in the communication network 100, such as e.g. a first peer 121 and a second peer 122. Note that the first and second peer 121, 122 may belong to the communication network 100 or be external entities, and that first and second peer 121, 122 may in some embodiments coincide, i.e., a request coming from the first peer 121, may be processed by the system and a response is returned to the same calling peer. This means that the first and second peer 121, 122 may be the same peer.

Further, the first and second peer 121, 122 may each be referred to as a UE, a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g., smart phone, laptop, mobile phone, sensor, relay, mobile tablets or even a small base station communicating via a RAN, e.g. VRAN.

Further, scheduler 130 operates in the communication network 100. The scheduler 130 manages allocations for workflows in the communication network 100.

Methods herein may be performed by the first and second peer 121, 122, and the scheduler 130. The first and second peer 121, 122, and the scheduler 130 may be Distributed Nodes and functionality, e.g. comprised in a cloud, and may be used for performing or partly performing the methods herein.

Example embodiments herein provide a method which enables a distribution of allocation options required for load balancing decisions to the service instances 111, 112, 113, 114, in the communications network 100 where these decisions are taken. It supports both authoritative decisions and recommendations with allocation options. Likewise, it supports LB decisions and recommendations per workflow execution (instance) and per workflow type, while other options include combinations of workflow instances and types having common attributes and characteristics. An advantage is that embodiments herein do not require potentially costly, in terms of time, runtime information retrieval of control information from an external entity, such as an online LB decision maker.

Example of embodiments herein targets use-cases in which LB is performed, in the communications network 110 e.g. a microservice-based system, with the goal of optimizing non-functional requirements, including time-sensitive objectives, or preserving constraints on them. If requests such as e.g. service requests, for which LB is performed correspond to known workflows spanning multiple services of known types, it is reasonable to exploit such known static structures and make decisions using the global information on the workflow and the non-functional requirements on its execution. This means that many scenarios involving constrained optimization may be efficiently supported. For example, given a workflow instance with a response time constraint, the service instances, such as the service instances 111, 112, 113, 114, corresponding to the service types defined by the known workflow structure may be chosen in a manner such that said constraint is preserved although, of the available service instances for each choice, not the one with the minimal individual response time is chosen at each step of the workflow. Service instances, such the service instances 111, 112, 113, 114, whose performance in terms of individual response time exceeds the one required by the workflow instance of interest may be dedicated to processing other workflow instances with more stringent requirements or left unused thus reducing resource consumption and/or cost.

To keep latency introduced by managing LB at minimum, it is advantageous that, according to embodiments herein, each time processing must be transferred to the next service instance, the information needed, that is set of allocation options, to choose a next service instance is available locally at the decision point. Additionally, it may be possible to offer alternatives for this choice.

By using an example of the method provided herein, when a workflow in a microservice-based environment such as e.g. the communications network 100, is enacted, each service executing a part, e.g. each service instance 111, 112, 113, 114, of the workflow in the distributed system is informed of set of allocation options e.g. comprising identity and location of the specific service instance(s) of other services, the service instance should transfer the processing to next e.g. successor instance. The identities are assumed to be pre-computed according to non-functional requirements which are generally known for a particular request at its arrival. Additionally, the identity and location information for a next service instance, also referred to as candidate successor, may be specified as a preference-ordered set of allocation options, a subset of all available candidate services of a kind, and e.g. along with expressions describing the strength of the preference. Thus, it is effectively an LB decision recommendation that is passed on in the form of set of allocation options such as e.g. a list of purpose-crafted expressions.

This set of allocation options may be transmitted in-band, i.e., on the same channel the services communicate data when processing the request of interest. The service instance currently performing partial processing does not need to fetch any information needed to make its local LB decision, when required, from any central control entity.

Advantages of examples of embodiments herein e.g. comprises the following:

Embodiments herein uses global LB-related information to be distributed to the service instances such as the chain of service instances 111, 112, 113, 114, which participate in the processing of the workflow instance. An advantage is that example embodiments herein do not require those instances to retrieve control information from a central entity controlling LB during the processing phase. Instead, it supports a distributed decision-making pattern which fits the distributed architecture of the communications network 100 such as e.g. microservice-based systems. In fact, by using this method, a pre-computed ordered set of preferences e.g. referred to as a set of allocation options, may be communicated to the service instances 111, 112, 113, 114, engaged in the processing of a request, but the decision which choice is ultimately made may be delegated to the service instances 111, 112, 113, 114, making it. As an alternative, an authoritative decision may still be enforced simply by providing only one option.

The rationale for the flexibility implemented by preferences is related to that there may exist a pre-computed optimal allocation, determining where a single specific workflow instance should be executed, which overrides a generic mapping describing where all workflows of that type should be run. As some of the previously recommended candidate service instances may become unreachable or overloaded, the “default” type-based preference may be enacted instead of the instance-based one. There are many other scenarios which may be implemented using embodiments herein. For example, it is possible to specify that a workflow instance of lower priority should be executed on some of the least performing service instances of a particular type.

These preferences may be transmitted in-band, i.e., on the same channel the services communicate data when processing the request of interest. Thus, no specialized channel, or asynchronous communication or look-up is necessary, and no additional delays are introduced as a side-effect of managing LB throughout the workflow execution.

A number of embodiments will now be described, some of which may be seen as alternatives, while some may be used in combination.

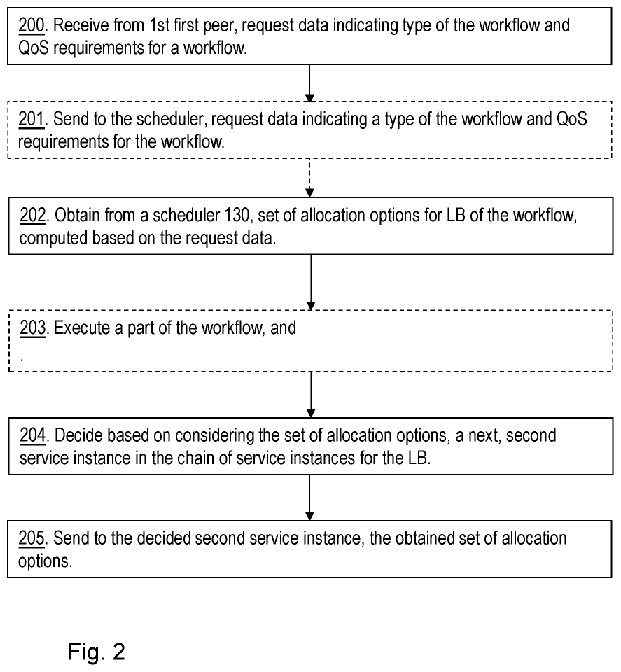

FIG. 2 shows example embodiments of method performed by the first service instance 111 for handling LB. The LB is for a workflow transmitted between the first peer 121 and the second peer 122 via a chain of service instances 111, 112, 113, 114 in a communications network 100. The first service instance 111 may in some embodiments be a UPCF node, and the communications network 100 may in some embodiments be a VRAN. A workflow when used herein may e.g. be a PDU session establishment along with the setup of a user plane data connection.

The method comprises the following actions, which actions may be taken in any suitable order. Optional actions are referred to as dashed boxes in FIG. 2. See also the arrows in FIG. 1.

### Action 200

The the first service instance 111 receives a request data from the first peer 121. The request data indicates a type of the workflow and quality of service QoS requirements for the workflow. The request data may be comprised in a request such as a service request.

### Action 201

In some embodiments, the first service instance 111 sends a request data to the scheduler 130. The request data indicates a type of the workflow and QoS requirements for the workflow.

### Action 202

The the first service instance 111 obtains a set of allocation options from the scheduler 130. The set of allocation options are for LB of the workflow. The set of allocation options are computed based on the request data. This will be described more in detail below. An allocation option when used herein means that the allocation is only a recommendation, and each service instance 111, 112, 113 in turn in the chain of service instances 111, 112, 113, 114, will decide a next service instance to be allocated, based on the recommendation.

Each allocation option in the set of allocation options, identifies a respective associated service instance out of the chain of service instances 111, 112, 113, 114. The allocation option is to be considered for an upcoming LB decision at an appropriate step of executing a part of the workflow. The chain of service instances 111, 112, 113, 114 comprises at least the first service instance 111, a second service instance 112 and a third service instance 113. In some embodiments, the chain of service instances further comprises one or more fourth service instances 114. The first service instance 111, the second service instance 112, the third service instance 113, and the fourth service instance 114 are comprised in a chain of service instances 111, 112, 113, 114.

This means that a first part of the workflow shall be executed by the first service instance 111, then a second part of the workflow shall be executed by the second service instance 112, then a third part of the workflow shall be executed by the third service instance 113, and then a fourth part of the workflow shall be executed by the fourth service instance 114.

The set of allocation options for LB may in some embodiments comprise a stack of textual expressions. Each textual expression comprises a reference identifying the respective associated service instance out of the chain of service instances 111, 112, 113, 114, to consider for the LB the decision at the appropriate step of the workflow execution. This will be described more in detail below.

In some embodiments each allocation option in the set of allocation options further comprises a value defining a strength of recommending the particular service instance, or in some of these embodiments, each textual expressions in the stack of textual expressions, further comprises a value defining a strength of recommending the particular service instance. A value defining a strength of recommending the particular service instance means a probability value that, making that choice will result in executing the workflow instance of interest in a way which satisfies the relevant associated constraints and optimizes the associated objectives the scheduler is aware of at the time of making the recommendation. This probability may be calculated based on the information available to the scheduler 130 at that same time. It may be the case that the service instance, such as the service instances 111, 112, 113, 114, actually making the LB decision obtains access to additional or updated information when that decision is made, e.g., when a service instance with a stronger recommendation has become unavailable or overloaded.

### Action 203

The the first service instance 111 may then execute its part of the workflow.

### Action 204

Based on considering the set of allocation options, the the first service instance 111 decides a next, a second service instance 112 in the chain of service instances 111, 112, 113, 114, for the LB.

### Action 205

The the first service instance 111 sends the obtained set of allocation options to the decided second service instance 112.

This enables the second service instance 112 at an appropriate step of executing the workflow, to consider the set of allocation options, for deciding a next, a third service instance 113 for the LB.

It further enables the second service instance 112 to forward the set of allocation options to the decided third service instance 113. This in turn enables the third service instance 113 at an appropriate step of executing the workflow, to consider the set of allocation options, for deciding if any remains, a further next fourth service instance 114 for the LB.

The set of allocation options for LB may be transmitted on a same channel as the service instances 111, 112,113, 114 communicate data when processing the service requests.

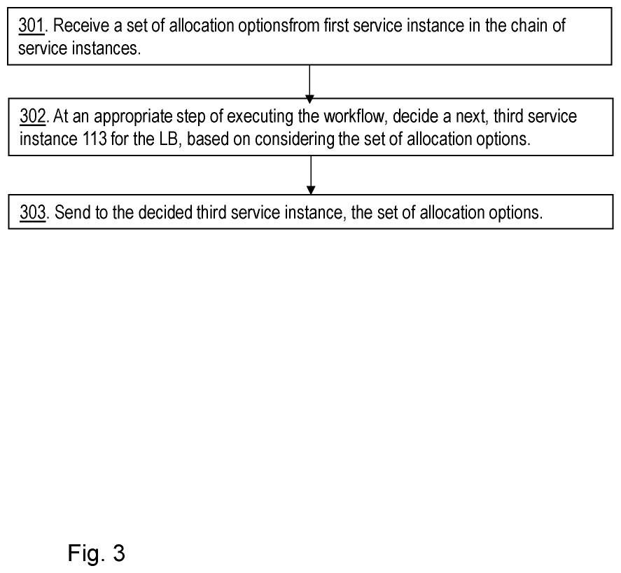

FIG. 3 shows example embodiments of a method performed by the second service instance 112 for handling LB. The second service instance 112 service instance is the next service instance in the chain of service instances 111, 112, 113, 114.

The LB is for a workflow transmitted between a first peer 121 and a second peer 122 via a chain of service instances 111, 112, 113, 114 in a communications network 100.

The method comprises the following actions, which actions may be taken in any suitable order. Optional actions are referred to as dashed boxes in FIG. 3.

### Action 301

The second service instance 112 receives a set of allocation options for LB of the workflow from the first service instance 111 in the chain of service instances 111, 112, 113, 114. In the set of allocation options, each allocation option identifies a respective associated service instance out of the chain of service instances 111, 112, 113, 114. The respective associated service instance is to be considered for an upcoming LB decision at an appropriate step of executing a part of the workflow. The chain of service instances 111, 112, 113, 114 comprises at least a first service instance 111, the second service instance 112 and a third service instance 113.

The set of allocation options for LB may in some embodiments comprise a stack of textual expressions. Each textual expression comprises a reference identifying the respective associated service instance out of the chain of service instances 111, 112, 113, 114, to consider for the LB the decision at the appropriate step of the workflow execution.

In some embodiments each allocation option in the set of allocation options further comprises a value defining a strength of recommending the particular service instance, or if applicable, each textual expressions in the stack of textual expressions, further comprises a value defining a strength of recommending the particular service instance.

### Action 302

At an appropriate step of executing the workflow, the second service instance 112 decides a next, a third service instance 113 for the LB, based on considering the set of allocation options.

### Action 303

The second service instance 112 sends the set of allocation options to the decided third service instance 113. This enables the third service instance 113 at an appropriate step of executing the workflow, to consider the set of allocation options, for deciding if any remains, a further next, a fourth service instance 114 for the LB.

In some embodiments, the set of allocation options for LB is transmitted on a same channel as the service instances 111, 112,113, 114 communicate data when processing the service requests.

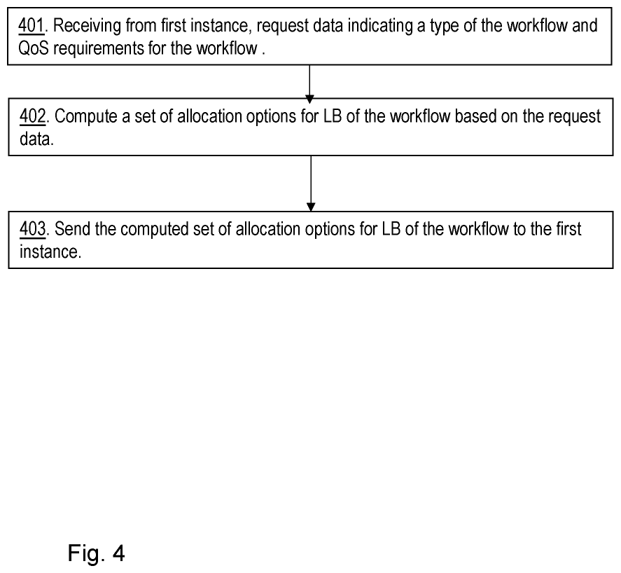

FIG. 4 shows example embodiments of a method performed by the scheduler 130 for handling LB. The LB is for a workflow transmitted between a first peer 121 and a second peer 122 via a chain of service instances 111, 112, 113, 114 in a communications network 100.

The method comprises the following actions, which actions may be taken in any suitable order. Optional actions are referred to as dashed boxes in FIG. 4.

### Action 401

The scheduler 130 receives a request data from the first instance 111. The request data indicates a type of the workflow and quality of service QoS requirements for the workflow.

### Action 402

The scheduler 130 computes a set of allocation options for LB of the workflow based on the request data. Each allocation option in the set of allocation options, identifies a respective associated service instance out of the chain of service instances 111, 112, 113, 114, to consider for an upcoming LB decision at an appropriate step of executing a part of the workflow. The chain of service instances 111, 112, 113, 114 comprises at least the first service instance 111, a second service instance 112 and a third service instance 113. This will be exemplified and described more in detail below.

The set of allocation options for LB may in some embodiments comprise a stack of textual expressions. Each textual expression comprises a reference identifying the respective associated service instance out of the chain of service instances 111, 112, 113, 114, to consider for the LB the decision at the appropriate step of the workflow execution.

In some embodiments each allocation option in the set of allocation options further comprises a value defining a strength of recommending the particular service instance, or in some of these embodiments, each textual expressions in the stack of textual expressions, further comprises a value defining a strength of recommending the particular service instance.

### Action 403

The scheduler 130 sends the computed set of allocation options for LB of the workflow to the first instance 111.

This enables the first instance 111 to decide a next, a second service instance 112 in the chain of service instances 111, 112, 113, 114, for the LB. The deciding is based on considering the set of allocation options. This further enables the first instance 111 to send the obtained set of allocation options to the decided second service instance 112.

This in turn enables the second service instance 112 at an appropriate step of executing the workflow, to consider the set of allocation options, for deciding a next, a third service instance 113 for the LB. And further, to forward the set of allocation options to the decided third service instance 113, to enable the third service instance 113 at an appropriate step of executing the workflow, to consider the set of allocation options, for deciding if any remains, a further next fourth service instance 114 for the LB.

The above embodiments will now be further explained and exemplified below. The embodiments below may be combined with any suitable embodiment above.

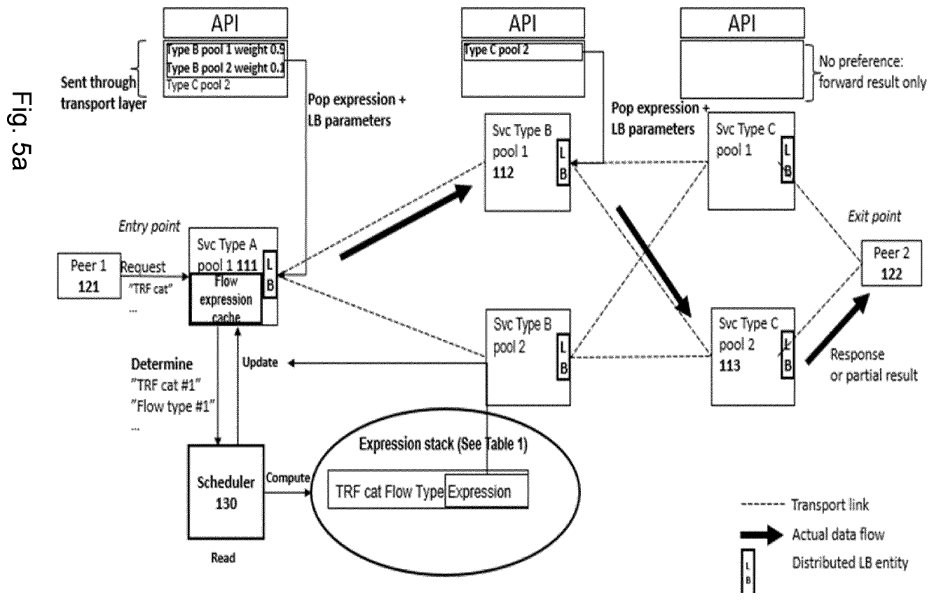

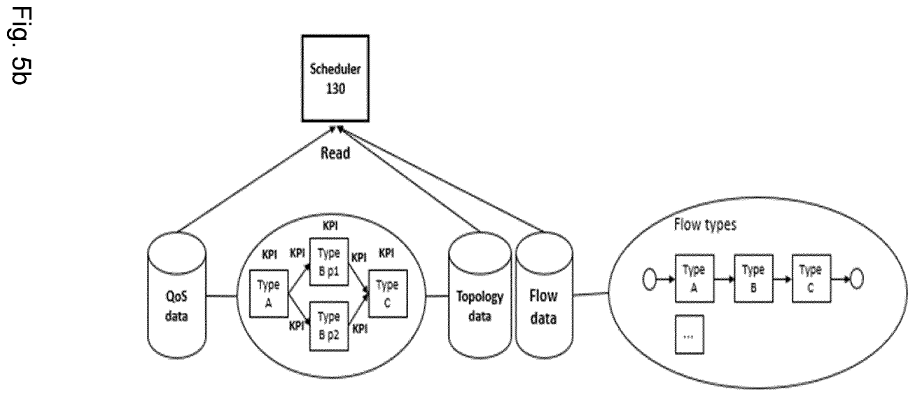

FIGS. 5a, 5b and FIGS. 6a, 6b depict two respective examples of the method.

The communications network 100 e.g. comprises a distributed system composed of a few pools of services of different types such as the chain of service instances 111, 112, 113, 114, connected by transport links. FIG. 5a shows a representative part of such a system, with entities of interest for embodiments herein marked in bold. Note that the first peer 121, referred to as Peer1 121 and the second peer 122, referred to as Peer2 122 in FIG. 5a, may belong to it or be external entities. Further, that Peer1 121 and Peer2 122 may coincide, i.e., a request coming from Peer1 121 may be processed by the system and a response returned to the same calling peer. I.e. the second peer 122, may be the same as the first peer 121.

In FIG. 5a, a service instance is referred to as svc, and a workflow is referred to as flow The QoS in this example is represented by a traffic category and is referred to as TRF cat in FIG. 5a.

When a request enters the part of the system described here, coming from Peer1 121, it is forwarded to the first service instance 111 within a pool of services. The first service instance 111 is of some Type A. The first service instance 111 may be regarded as an entry point. At the entry point, the first service instance 111 extracts from the request data, the type of workflow, and its traffic category or any other characteristics relevant for the QoS required by it. This is related to and may be combined with Action 200 described above.

The extracted the type of workflow, and its traffic category is communicated by the first service instance 111 to the Scheduler 130. This is related to and may be combined with Action 401 described above.

The Scheduler 130 computes the set of allocation options for LB of the workflow. This is related to and may be combined with Action 402 described above. The set of allocation options e.g. comprises the options for allocating the flow to the service pools available in the system. The set of allocation options comprises an ordered set of preferred allocations for a workflow. This relates to the chain of service instances 111, 112, 113, 114 pointing out that the workflow shall be executed by a service instance in an order that is pointed out by the chain. This means that a first part of the workflow shall be executed by the first service instance 111, then a second part of the workflow shall be executed by the second service instance 112, then a third part of the workflow shall be executed by the third service instance 113, and then a fourth part of the workflow shall be executed by the fourth service instance 114. A corresponding set of allocation options is thus computed by the scheduler 130, as a recommendation. Note that the service pools are distinct in location and non-functional characteristics, and they play the role of service instances such as the service instances 111, 112, 113, 114, to which allocations are referred when the embodiments herein were described in less detail above.

The scheduler 130 computes the set of allocation options based on the type of the workflow and QoS requirements for the workflow, such as its traffic category in this example. This may for example be a knowledge of a workflow structure and non-functional requirements for a given workflow instance, and the scheduler 130 may employ different constrained optimization algorithms. To do so, the scheduler 130 may use a number of underlying databases, shown FIG. 5b, in particular a data store with models of known workflow types, referred to as Flow data, one with the locations, links and other characteristics of the available service pools referred to as Topology data and a DB containing historical QoS data for workflow instances run in the system and their (past) allocations. The last data store may be processed, e.g., by machine learning software supporting the decision-making mechanism.

Embodiments herein may not prescribe particular optimization algorithms or the specifics of the data sources. However, they may assume that the Scheduler 130 shall determine an ordered set of preferred allocations for a workflow. This set of preferences may take the form of a stack of textual expressions referred to as Expression stack in FIG. 5a, each including a reference to an identity of a service instance to consider for an LB decision at an appropriate step of the workflow execution, along with a value determining the strength of the preference. See in Table 1 below an example of the expression stack.

TABLE 1

| TRF cat | Flow Type | Expression |
|---|---|---|
| #1 | #1 | Type B pool 1 weight 0.9 |
| | | Type B pool 2 weight 0.1 |
| | | Type C pool 2 |
| | . . . | |
| #2 | | |
| . . . | | |

The preferred allocations for a workflow type and QoS, e.g. traffic, category, if the scheduler 130 is not configured to re-compute them for each service instance of that type, may be optionally cached in an appropriate region of memory e.g. referred to as Flow expression cache”, available to Type A services.

The set of allocation options calculated by the scheduler is sent back to the first service instance 111. This is related to and may be combined with Action 202 and 403 described above.

In any event, for each request, and thus workflow instance, the set of allocation options such as e.g. the set of expressions, relevant to it is forwarded, along with the request data and on the same channel, to each service instance 111, 112, 113, 114, e.g. pool, effectively chosen for processing. This is related to and may be combined with Action 205, 301 and 303 described above. The actual flow of all data is shown by the bold arrows in FIG. 5a, from the first service instance 111 to the second service instance 112, from the second service instance 112 to the third service instance 113, and from the third service instance 113 to the second Peer 122.

Specifically, when a service instance 111, 112, 113, 114 completes its partial processing of the request, in the case of a Type A service, this is just fetching the expression stack from the Scheduler 130 or its own cache, a decision is taken by the service instance 111, 112, 113, 114, the load balancing sub-service within the service where to forward the data partially processed. This is related to and may be combined with Action 204 and 302 described above. For the reasons outlined previously, this decision takes into consideration one of allocation options in the set of allocation options for LB of the workflow (not necessarily the first one) the service originally received along with the request data. All the LB preference data relative to the decision just taken may be removed from the expression as it is no longer of use, see Application Programming Interface (API) boxes on the top of FIG. 5a. LB preference data when used herein may mean the rows in the table within the smallest rectangle in each of the API boxes of FIG. 5a, which comprise the possible options for the decision just taken, including the option actually chosen and the options discarded.

In contrast to a user interface, which connects a computer to a person, an application programming interface connects computers or pieces of software to each other. An API is a connection between computers or between computer programs. It is a type of software interface, offering a service to other pieces of software. Part of the interface between the service instances 111, 112, 113, 114 interacting herein may be the manner they communicate and process LB allocation options as outlined above.

FIGS. 6a and 6b show another example of a fragment of a VRAN which processes a Radio Resource Control (RRC) setup request up to the start of data flow in a user plane. In FIG. 6a, a workflow is referred to as flow The QoS in this example is represented by a traffic category and is referred to as TRF cat in FIG. 6a.

Note that the first peer 121, is referred to as UE side 121 and the second peer 122, is referred to as packet processing function 122 in FIG. 6a.

In FIG. 6a, the first service instance 111 is referred to as User Plane Control Function (UPCF) 111, the second service instance 112, is referred to as a Cell Control Function 112, and the third service instance 113, is referred to as UE Control Function 113.

Note that in reality components of the VRAN shown, in this case pools of services implementing virtualized network functions, exchange many messages in a protocol-specific order, e.g., in 5G, in accordance with standards where applicable, before data flow is started. For simplicity, this is omitted in FIG. 5a, where only the core in-band load balancing decision making method and its flow are shown, referred to as bold numbered arrows.

Specifically, during a message exchange, there are specific steps when a new type of service is first engaged by a peer, e.g., when in step 3, a UEF first communicates with a PPF. By assumption there are multiple, fully functionally equivalent pools of services realizing some network functions: Two pools of CellFs and two of PPFs in the example, each having different non-functional characteristics. Thus, the UPCF processing the request shall preferably make an LB decision at the latest when it first starts sending any data to a CellF. Likewise, the UEF must make a LB decision at the latest when it first starts sending any data to a PPF. In the scenario shown, this is implemented by applying the embodiments. When a request, in this example an RRC Setup request, arrives into the system (fragment), the intercepting service instance, the UPCF 111 in this case, acts as the entry point. The UPCF 111 extracts, from the request data, the type of workflow, its traffic category, and any other characteristics relevant for the quality of service (QOS) required by it. This is related to and may be combined with Action 200 described above.

The extracted the type of workflow, its traffic category, and any other characteristics relevant for the quality of service (QOS) required by it are communicated by the UPCF 111 to the Scheduler 130. This is related to and may be combined with Action 202 described above.

The Scheduler 130 returns to the UPCF 111 a complete set of allocation options for LB of the workflow, in this example a complete expression stack comprising all the of allocation options e.g. preference-weighted options for allocating the remaining parts of this workflow instance to the CellF 112, the UEF 113 and the PPF 122 instance pools available in the system. See in Table 2 below an example of the expression stack. This is related to and may be combined with Action 202 and Action 403 described above.

TABLE 2

| TRF cat | Flow Type | Expression |
|---|---|---|
| #1 | RRCS | CellF pool 1 weight 0.9 |
| | | CellF pool 2 weight 0.1 |
| | | Type C pool 2 |
| | | UEF |
| | | PPF pool 2 weight 0.6 |
| | | PPF pool 1 weight 0.4 |
| | . . . | |
| #2 | | |
| . . . | | |

These options are computed by the Scheduler e.g. by using any constrained optimization approaches at its discretion. To compute this, the scheduler 130 may use a number of underlying databases, shown FIG. 6b. This is related to and may be combined with Action 402 described above. in particular a data store with models of known workflow types, referred to as Flow data, one with the locations, links and other characteristics of the available service pools referred to as Topology data and a DB containing historical QoS data for workflow instances run in the system and their (past) allocations. The last data store may be processed, e.g., by machine learning software supporting the decision-making mechanism.

During execution, the distributed load balancers such as the In FIG. 6a, the first service instance 111 referred to as UPCF 111, the second service instance 112, referred to as a Cell Control Function 112, and the third service instance 113, is referred to as UEF 113 within the services may still decide choose a secondary option as instructed by their own logic (see step 3), e.g., when the service specified by the default option has become unavailable in the meantime. This is related to and may be combined with Action 204 and Action 302 described above.

### Other Possible Implementations

By using the provided method according to embodiments herein, the set of allocation options needed for making the LB decisions of the workflow, may transmitted in-band, i.e., on the same channel the services communicate data when processing the request of interest. The advantage of this approach is that no retrieval of control information is required from some external entity such as the Scheduler 130 when a load balancing decision is taken and, importantly, no latency due to side-channel communication is introduced. However, the set of allocation options such as the set of preferred allocation options is pre-determined as a whole for all LB decisions along the timeline of the execution and may become outdated.

This leads to the observation that, especially for longer-running workflows, a better set of allocation options may be determined, at some point in time, for the remaining part of the workflow, i.e., one which is updated with respect to the optimization objectives of interest. For less time-sensitive workflows and when other optimization objectives may still be improved, it is actually feasible and may be of advantage to re-compute allocations at runtime, e.g., periodically. In such cases it makes sense to add a side-channel to pass control information between service instances and the central load balancer entity. In its original formulation, examples of embodiments herein do not require the use of side channels but does not preclude it either, thus it may easily be altered to take the considerations above into account.

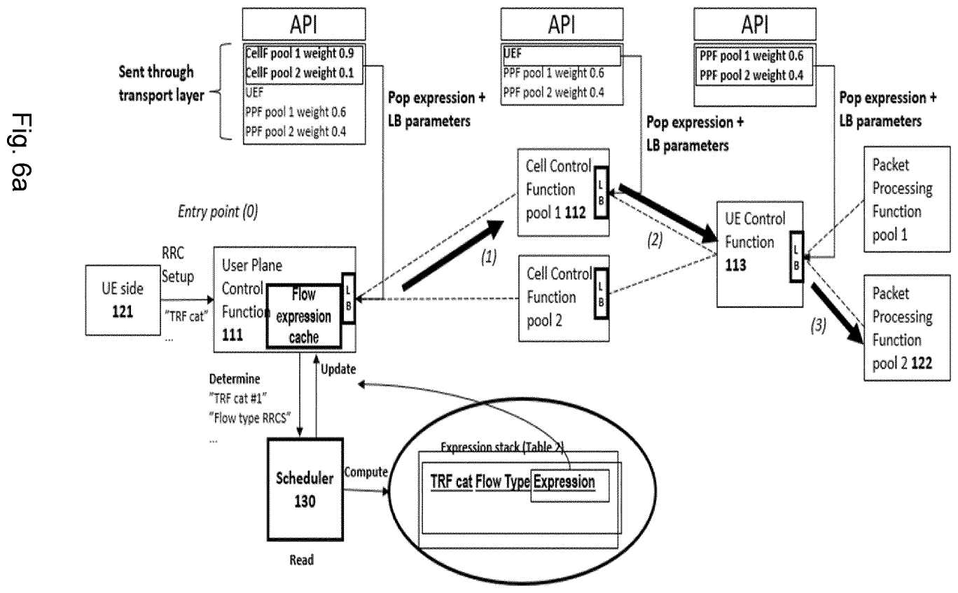

To perform the method actions above, the first service instance 111 is configured to handle LB. The LB is adapted for a workflow to be transmitted between the first peer 121 and the second peer 122 via a chain of service instances 111, 112, 113, 114 in the communications network 100. The first service instance 111 may comprise an arrangement depicted in FIGS. 7a and 7b.

The first service instance 111 may comprise an input and output interface 700 configured to communicate with the first peer 121, the scheduler and the second service instance. The input and output interface 300 may comprise a receiver not shown and a transmitter not shown.

The first service instance 111 may further be configured to, e.g., by means of a receiving unit 710, receive a request data from the first peer 121, which request data is adapted to indicate a type of the workflow and quality of service QoS requirements for the workflow.

The first service instance 111 may further be configured to, e.g., by means of an obtaining unit 720, obtain from a scheduler 130 a set of allocation options for LB of the workflow, computed based on the request data. Each allocation option in the set of allocation options, is adapted to identify a respective associated service instance out of the chain of service instances 111, 112, 113, 114, to consider for an upcoming LB decision at an appropriate step of executing a part of the workflow. The chain of service instances 111, 112, 113, 114 is adapted to comprise at least the first service instance 111, a second service instance 112 and a third service instance 113.

The first service instance 111 may further be configured to, e.g., by means of a deciding unit 730, decide based on considering the set of allocation options, a next, a second service instance 112 in the chain of service instances 111, 112, 113, 114, for the LB.

The first service instance 111 may further be configured to, e.g., by means of a sending unit 735, send to the decided second service instance 112, the obtained set of allocation options,
enabling the second service instance 112 at an appropriate step of executing the workflow, to consider the set of allocation options, for deciding a next, a third service instance 113 for the LB, and to
forward the set of allocation options to the decided third service instance 113, to enable the third service instance 113 at an appropriate step of executing the workflow, to consider the set of allocation options, for deciding if any remains, a further next fourth service instance 114 for the LB.

In some embodiments, the set of allocation options for LB is to be transmitted on a same channel as the service instances 111, 112,113, 114 communicate data when processing the service requests.

In some embodiments, the set of allocation options for LB is adapted to comprise a stack of textual expressions, where each textual expression is adapted to comprise a reference identifying the respective associated service instance out of the chain of service instances 111, 112, 113, 114, to consider for the LB the decision at the appropriate step of the workflow execution.

In some embodiments, any one out of.

Each allocation option in the set of allocation options further is adapted to comprise a value defining a strength of recommending the particular service instance, or each textual expressions in the stack of textual expressions, further is adapted to comprise a value defining a strength of recommending the particular service instance.

The embodiments herein may be implemented through a respective processor or one or more processors, such as the processor 740 of a processing circuitry in the first service instance 111 depicted in FIG. 7a, together with respective computer program code for performing the functions and actions of the embodiments herein. The program code mentioned above may also be provided as a computer program product, for instance in the form of a data carrier carrying computer program code for performing the embodiments herein when being loaded into the first service instance 111. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 750 comprising one or more memory units. The memory 750 comprises instructions executable by the processor in the first service instance 111. The memory 750 is arranged to be used to store e.g. information, indications, symbols, data, configurations, and applications to perform the methods herein when being executed in the first service instance 111.

In some embodiments, a computer program 760 comprises instructions, which when executed by the respective at least one processor 750, cause the at least one processor of the network node 110 to perform the actions above.

In some embodiments, a respective carrier 770 comprises the respective computer program 760, wherein the carrier 770 is one of an electronic signal, an optical signal, an electromagnetic signal, a magnetic signal, an electric signal, a radio signal, a microwave signal, or a computer-readable storage medium.

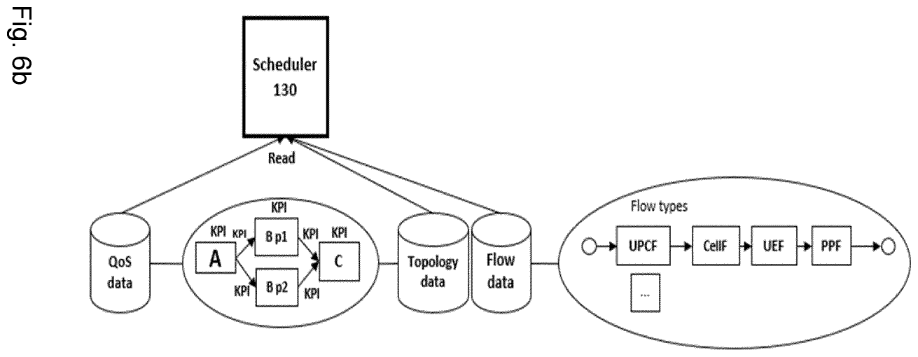

To perform the method actions above, the second service instance 112 configured to handle LB. The LB is adapted for a workflow to be transmitted between a first peer 121 and a second peer 122 via a chain of service instances 111, 112, 113, 114 in a communications network 100. The second service instance 112 may comprise an arrangement depicted in FIGS. 8a and 8b

The second service instance 112 may comprise an input and output interface 800 configured to communicate with service instances such as the first service instance 111 and the third service instance 113. The input and output interface 800 may comprise a receiver not shown and a transmitter not shown.

The second service instance 112 may further be configured to, e.g. by means of a receiving unit 810, receive from the first service instance 111 in the chain of service instances 111, 112, 113, 114, a set of allocation options for LB of the workflow, where each allocation option in the set of allocation options, is adapted to identify a respective associated service instance out of the chain of service instances 111, 112, 113, 114, to consider for an upcoming LB decision at an appropriate step of executing a part of the workflow, wherein the chain of service instances 111, 112, 113, 114 is adapted to comprise at least a first service instance 111, the second service instance 112 and a third service instance 113.

The second service instance 112 may further be configured to, e.g. by means of a deciding unit 820, at an appropriate step of executing the workflow, decide a next, a third service instance 113 for the LB, based on considering the set of allocation options.

The second service instance 112 may further be configured to, e.g. by means of a sending unit 830, send to the decided third service instance 113, the set of allocation options, enabling the third service instance 113 at an appropriate step of executing the workflow, to consider the set of allocation options, for deciding if any remains, a further next, a fourth service instance 114 for the LB.

In some embodiments, the set of allocation options for LB is to be transmitted on a same channel as the service instances 111, 112,113, 114 communicate data when processing the service requests.

In some embodiments, the set of allocation options for LB is adapted to comprise a stack of textual expressions, where each textual expression is adapted to comprise a reference identifying the respective associated service instance out of the chain of service instances 111, 112, 113, 114, to consider for the LB the decision at the appropriate step of the workflow execution.

In some embodiments, any one out of.

Each allocation option in the set of allocation options further is adapted to comprise a value defining a strength of recommending the particular service instance, or
each textual expressions in the stack of textual expressions, further is adapted to comprise a value defining a strength of recommending the particular service instance.

The embodiments herein may be implemented through a respective processor or one or more processors, such as the processor 840 of a processing circuitry in the second service instance 112 depicted in FIG. 8a, together with respective computer program code for performing the functions and actions of the embodiments herein. The program code mentioned above may also be provided as a computer program product, for instance in the form of a data carrier carrying computer program code for performing the embodiments herein when being loaded into the second service instance 112. One such carrier may be in the form of a CD ROM disc. It is however feasible with other data carriers such as a memory stick. The computer program code may furthermore be provided as pure program code on a server and downloaded to the network node 110.

The second service instance 112 may further comprise a memory 850 comprising one or more memory units. The memory 850 comprises instructions executable by the processor in the second service instance 112. The memory 850 is arranged to be used to store e.g. information, indications, symbols, data, configurations, and applications to perform the methods herein when being executed in the second service instance 112.

In some embodiments, a computer program 860 comprises instructions, which when executed by the respective at least one processor 840, cause the at least one processor of the second service instance 112 to perform the actions above.

In some embodiments, a respective carrier 870 comprises the respective computer program 860, wherein the carrier 870 is one of an electronic signal, an optical signal, an electromagnetic signal, a magnetic signal, an electric signal, a radio signal, a microwave signal, or a computer-readable storage medium.

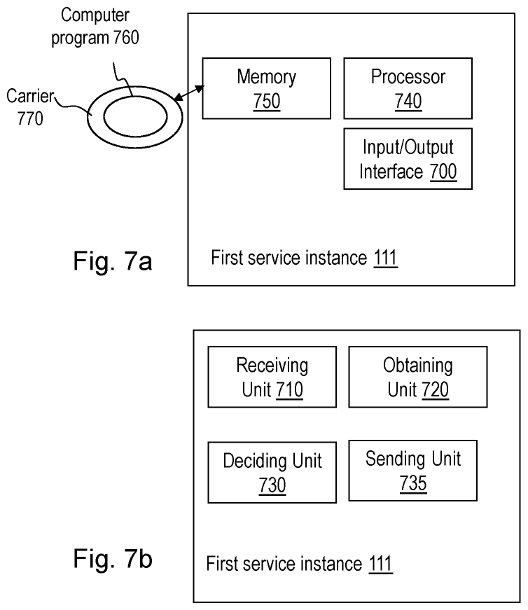

To perform the method actions above, the scheduler 130 is configured to handle LB. The LB is adapted for a workflow to be transmitted between the first peer 121 and the second peer 122 via a chain of service instances 111, 112, 113, 114 in the communications network 100. The scheduler 130 may comprise an arrangement depicted in FIGS. 9a and 9b.

The scheduler 130 may comprise an input and output interface 900 configured to communicate with service instances such as the first service instance 111. The input and output interface 900 may comprise a receiver not shown and a transmitter not shown.

The scheduler 130 may further be configured to, e.g. by means of a receiving unit 910, receive from the first instance 111, a request data, which request data is adapted to indicate a type of the workflow and quality of service QoS requirements for the workflow.

The scheduler 130 may further be configured to, e.g. by means of a computing unit 920, compute a set of allocation options for LB of the workflow based on the request data, where each allocation option in the set of allocation options, is adapted to identify a respective associated service instance out of the chain of service instances 111, 112, 113, 114, to consider for an upcoming LB decision at an appropriate step of executing a part of the workflow, wherein the chain of service instances 111, 112, 113, 114 is adapted to comprise at least the first service instance 111, a second service instance 112 and a third service instance 113.

The scheduler 130 may further be configured to, e.g. by means of a sending unit 930, send the computed set of allocation options for LB of the workflow to the first instance 111,
enabling the first instance 111 to decide, based on considering the set of allocation options, a next, a second service instance 112 in the chain of service instances 111, 112, 113, 114, for the LB, and to send to the decided second service instance 112, the obtained set of allocation options,
enabling the second service instance 112 at an appropriate step of executing the workflow, to consider the set of allocation options, for deciding a next, a third service instance 113 for the LB, and to forward the set of allocation options to the decided third service instance 113, to enable the third service instance 113 at an appropriate step of executing the workflow, to consider the set of allocation options, for deciding if any remains, a further next fourth service instance 114 for the LB.

In some embodiments, the set of allocation options for LB is adapted to comprise a stack of textual expressions, where each textual expression is adapted to comprise a reference identifying the respective associated service instance out of the chain of service instances 111, 112, 113, 114, to consider for the LB the decision at the appropriate step of the workflow execution.

In some embodiments, any one out of.

Each allocation option in the set of allocation options further is adapted to comprise a value defining a strength of recommending the particular service instance, or
each textual expressions in the stack of textual expressions, further is adapted to comprise a value defining a strength of recommending the particular service instance.

The embodiments herein may be implemented through a respective processor or one or more processors, such as the processor 940 of a processing circuitry in the scheduler 130 depicted in FIG. 9a, together with respective computer program code for performing the functions and actions of the embodiments herein. The program code mentioned above may also be provided as a computer program product, for instance in the form of a data carrier carrying computer program code for performing the embodiments herein when being loaded into the scheduler 130. One such carrier may be in the form of a CD ROM disc. It is however feasible with other data carriers such as a memory stick. The computer program code may furthermore be provided as pure program code on a server and downloaded to the scheduler 130.

The scheduler 130 may further comprise a memory 950 comprising one or more memory units. The memory 950 comprises instructions executable by the processor in the scheduler 130. The memory 950 is arranged to be used to store e.g. information, indications, symbols, data, configurations, and applications to perform the methods herein when being executed in the scheduler 130.

In some embodiments, a computer program 960 comprises instructions, which when executed by the respective at least one processor 940, cause the at least one processor of the scheduler 130 to perform the actions above.

In some embodiments, a respective carrier 970 comprises the respective computer program 960, wherein the carrier 970 is one of an electronic signal, an optical signal, an electromagnetic signal, a magnetic signal, an electric signal, a radio signal, a microwave signal, or a computer-readable storage medium.

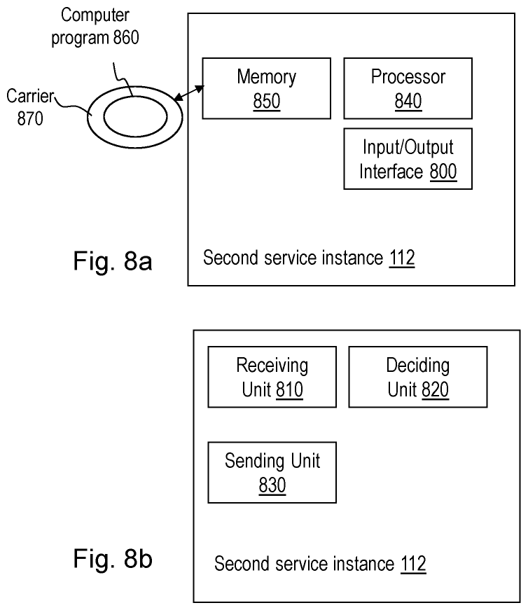

With reference to FIG. 10, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291, e.g. the UE 120, located in coverage area 3213c is configured to wirelessly connect to, or be paged by, the corresponding base station 3212c. A second UE 3292 e.g. the UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

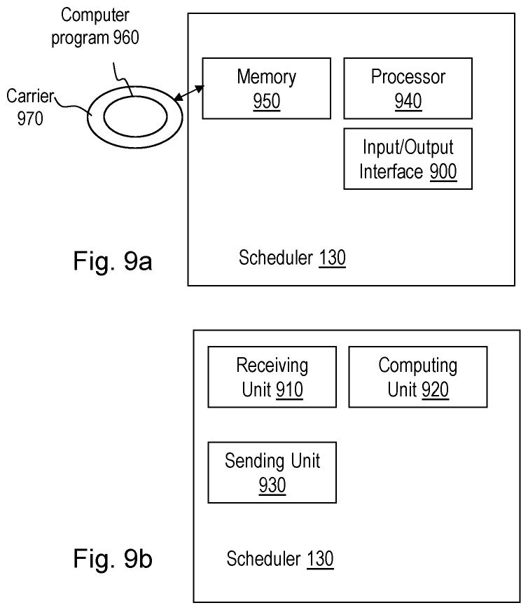

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

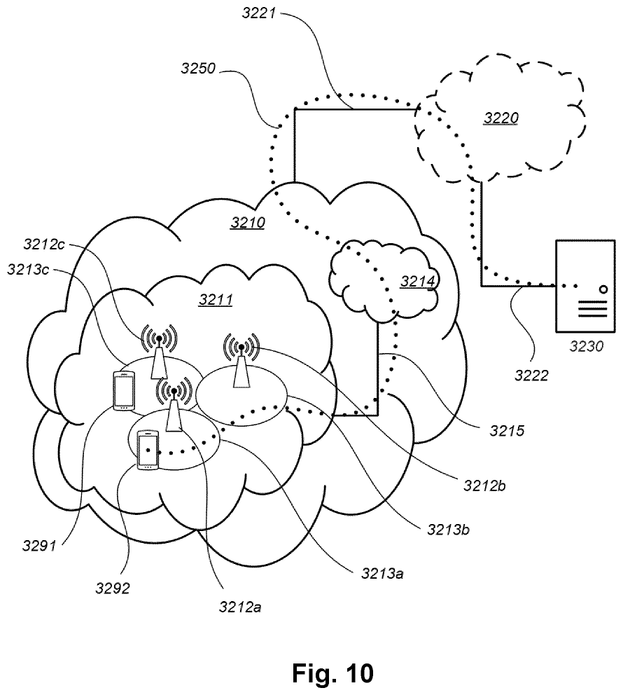

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

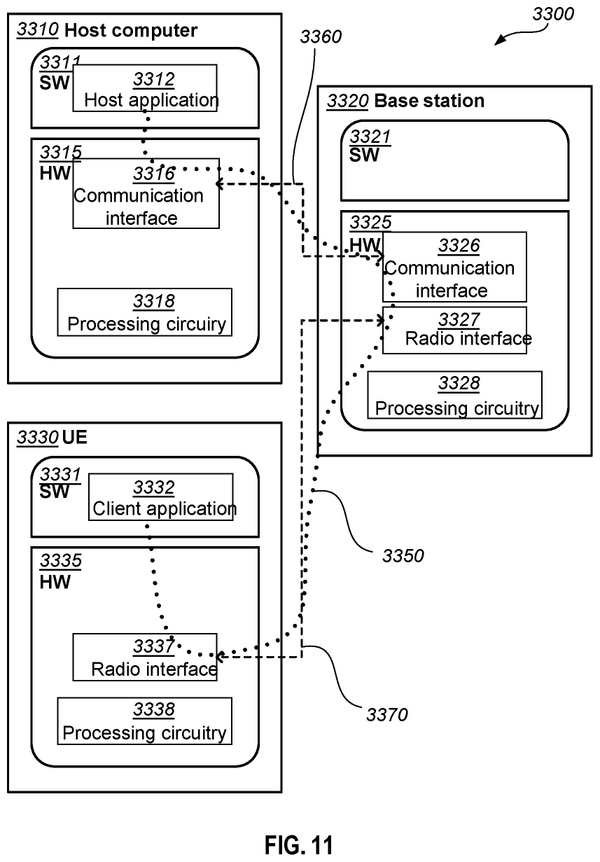

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

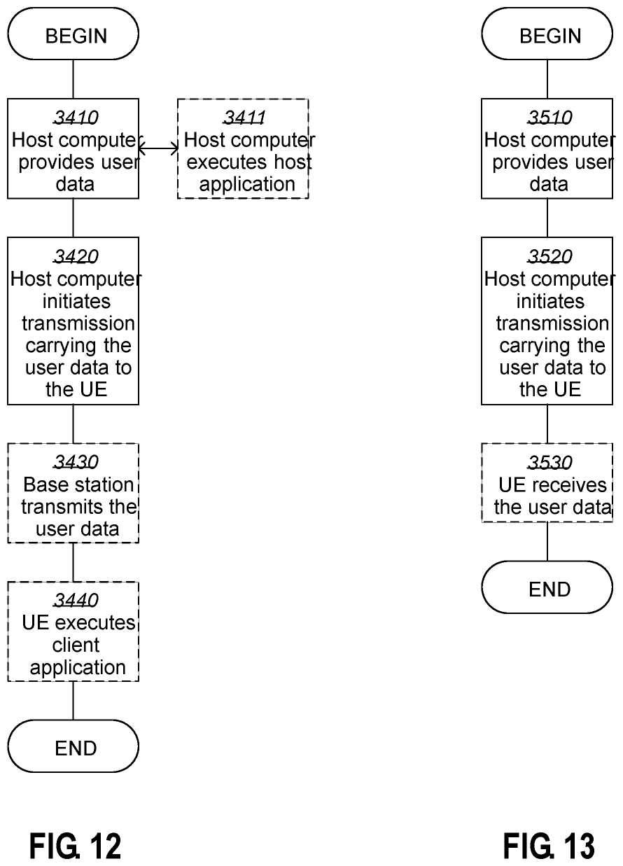

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

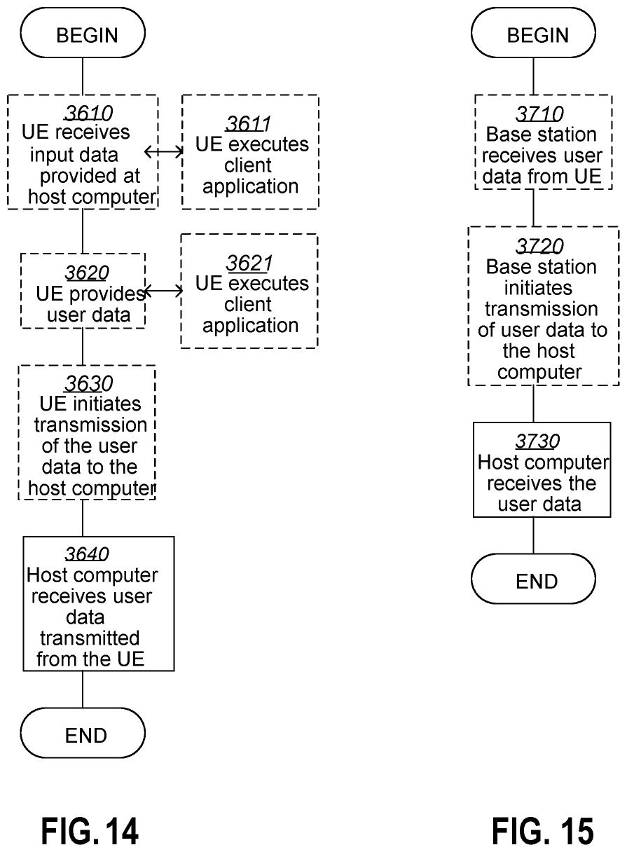

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATIONS

### Explain all Abbreviations and Acronyms Used in the Document.

### Abbreviation Explanation

BE: back-end
LB: load balancing
NFR: non-functional requirement
QoS: quality of service
RAN: radio access network
SLA: service-level agreement
VRAN: virtualized radio access network

The invention claimed is:

1. A method performed by a first service instance for handling Load Balancing, LB, which LB is for a workflow transmitted between a first peer and a second peer via a chain of service instances in a communications network, the method comprising:
receiving a request data from the first peer, which request data indicating a type of the workflow and quality of service, QoS, requirements for the workflow;
obtaining from a scheduler a set of allocation options for LB of the workflow, computed based on the request data;
where each allocation option in the set of allocation options identifies a respective associated service instance out of the chain of service instances, to consider for an upcoming LB decision at a step of executing a part of the workflow, the chain of service instances comprising at least the first service instance, a second service instance and a third service instance;
deciding based on considering the set of allocation options, a next, a second service instance in the chain of service instances, for the LB;
sending to the decided second service instance, the obtained set of allocation options;
enabling the second service instance at a step of executing the workflow, to consider the set of allocation options, for deciding a next, a third service instance for the LB; and to
forward the set of allocation options to the decided third service instance, to enable the third service instance at a step of executing the workflow, to consider the set of allocation options, for deciding if any remains, a further next fourth service instance for the LB.

2. The method according to claim 1, wherein the set of allocation options for LB is transmitted on a same channel as the service instances communicate data when processing the service requests.

3. The method according to claim 1, wherein the set of allocation options for LB comprises a stack of textual expressions, where each textual expression comprises, a reference identifying the respective associated service instance out of the chain of service instances, to consider for the LB the decision at the step of the workflow execution.

4. The method according to claim 1, wherein any one out of;
each allocation option in the set of allocation options further comprises a value defining a strength of recommending the particular service instance; or
each textual expressions in the stack of textual expressions, further comprises a value defining a strength of recommending the particular service instance.

5. (canceled)

6. (canceled)

7. A method performed by a second service instance for handling Load Balancing, LB, which LB is for a workflow transmitted between a first peer and a second peer via a chain of service instances in a communications network, the method comprising:
receiving from the first service instance in the chain of service instances, a set of allocation options for LB of the workflow, where each allocation option in the set of allocation options identifies a respective associated service instance out of the chain of service instances, to consider for an upcoming LB decision at a step of executing a part of the workflow, the chain of service instances comprising at least a first service instance, the second service instance and a third service instance;
at a step of executing the workflow, deciding a next, a third service instance for the LB, based on considering the set of allocation options;
sending to the decided third service instance, the set of allocation options, enabling the third service instance at a step of executing the workflow to consider the set of allocation options for deciding if any remains, a further next, a fourth service instance for the LB.

8. The method according to claim 7, wherein the set of allocation options for LB is transmitted on a same channel as the service instances communicate data when processing the service requests.

9. The method according to claim 7, wherein the set of allocation options for LB comprises a stack of textual expressions, where each textual expression comprises, a reference identifying the respective associated service instance out of the chain of service instances, to consider for the LB the decision at the step of the workflow execution.

10. The method according to claim 7, wherein any one out of:
each allocation option in the set of allocation options further comprises a value defining a strength of recommending the particular service instance; or
each textual expressions in the stack of textual expressions, further comprises a value defining a strength of recommending the particular service instance.

11. (canceled)

12. (canceled)

13. A method performed by a scheduler for handling Load Balancing, LB, which LB is for a workflow transmitted between a first peer and a second peer via a chain of service instances in a communications network, the method comprising:
receiving from the first instance, a request data, which request data indicates a type of the workflow and quality of service, QoS, requirements for the workflow;
computing a set of allocation options for LB of the workflow based on the request data, where each allocation option in the set of allocation options identifies a respective associated service instance out of the chain of service instances, to consider for an upcoming LB decision at an appropriate a step of executing a part of the workflow, the chain of service instances comprising at least the first service instance, a second service instance and a third service instance;
sending the computed set of allocation options for LB of the workflow to the first instance;
enabling the first instance to decide, based on considering the set of allocation options, a next, a second service instance in the chain of service instances, for the LB, and to send to the decided second service instance, the obtained set of allocation options;
enabling the second service instance at a step of executing the workflow, to consider the set of allocation options, for deciding a next, a third service instance for the LB, and to forward the set of allocation options to the decided third service instance, to enable the third service instance at a step of executing the workflow, to consider the set of allocation options, for deciding if any remains, a further next fourth service instance for the LB.

14. The method according to claim 13, wherein the set of allocation options for LB comprises a stack of textual expressions, where each textual expression comprises, a reference identifying the respective associated service instance out of the chain of service instances, to consider for the LB the decision at the step of the workflow execution.

15. The method according to claim 13, wherein any one out of;
each allocation option in the set of allocation options further comprises a value defining a strength of recommending the particular service instance; or
each textual expressions in the stack of textual expressions, further comprises a value defining a strength of recommending the particular service instance.

16. (canceled)

17. (canceled)

18. A first service instance configured to handle Load Balancing, LB, which LB is adapted for a workflow to be transmitted between a first peer and a second peer via a chain of service instances in a communications network, the first service instance further being configured to:
receive a request data from the first peer, which request data is adapted to indicate a type of the workflow and quality of service, QoS, requirements for the workflow;
obtain from a scheduler a set of allocation options for LB of the workflow, computed based on the request data;
where each allocation option in the set of allocation options is configured to identify a respective associated service instance out of the chain of service instances, to consider for an upcoming LB decision at a step of executing a part of the workflow, the chain of service instances being configured to comprise at least the first service instance, a second service instance and a third service instance;
decide based on considering the set of allocation options, a next, a second service instance in the chain of service instances, for the LB;
send to the decided second service instance, the obtained set of allocation options, enabling the second service instance at a step of executing the workflow to consider the set of allocation options, for deciding a next, a third service instance for the LB; and to
forward the set of allocation options to the decided third service instance, to enable the third service instance at a step of executing the workflow to consider the set of allocation options, for deciding if any remains, a further next fourth service instance for the LB.

19. The first service instance according to claim 18, wherein the set of allocation options for LB is to be transmitted on a same channel as the service instances communicate data when processing the service requests.

20. The first service instance according to claim 18, wherein the set of allocation options for LB is adapted to comprise a stack of textual expressions, where each textual expression includes a reference identifying the respective associated service instance out of the chain of service instances, to consider for the LB the decision at the appropriate step of the workflow execution.

21. The first service instance according to claim 18, wherein any one out of;
each allocation option in the set of allocation options further is adapted to comprise a value defining a strength of recommending the particular service instance; or
each textual expressions in the stack of textual expressions, further is adapted to comprise a value defining a strength of recommending the particular service instance.

22. A second service instance configured to handle Load Balancing, LB, which LB is adapted for a workflow to be transmitted between a first peer and a second peer via a chain of service instances in a communications network, the second service instance further being configured to:
receive from the first service instance in the chain of service instances, a set of allocation options for LB of the workflow, where each allocation option in the set of allocation options is configured to identify a respective associated service instance out of the chain of service instances, to consider for an upcoming LB decision at a step of executing a part of the workflow, the chain of service instances comprising at least a first service instance, the second service instance and a third service instance;
at a step of executing the workflow, decide a next, a third service instance for the LB, based on considering the set of allocation options; and
send to the decided third service instance, the set of allocation options, enabling the third service instance at a step of executing the workflow to consider the set of allocation options for deciding if any remains, a further next, a fourth service instance for the LB.

23. The second service instance according to claim 22, wherein the set of allocation options for LB is configured to be transmitted on a same channel as the service instances communicate data when processing the service requests.

24. The second service instance according to claim 22, wherein the set of allocation options for LB comprises a stack of textual expressions, where each textual comprises a reference identifying the respective associated service instance out of the chain of service instances, to consider for the LB the decision at the appropriate step of the workflow execution.

25. The second service instance according to claim 22, wherein any one out of;
each allocation option in the set of allocation options further is adapted to comprise a value defining a strength of recommending the particular service instance; or
each textual expressions in the stack of textual expressions further comprises a value defining a strength of recommending the particular service instance.

26. A scheduler configured to handle Load Balancing, LB, which LB is adapted for a workflow to be transmitted between a first peer and a second peer via a chain of service instances in a communications network, the scheduler further being configured to:
receive from the first instance, a request data, which request data is configured to indicate a type of the workflow and quality of service, QoS, requirements for the workflow;
compute a set of allocation options for LB of the workflow based on the request data, where each allocation option in the set of allocation options is configured to identify a respective associated service instance out of the chain of service instances, to consider for an upcoming LB decision at a step of executing a part of the workflow, the chain of service instances comprising at least the first service instance, a second service instance and a third service instance;
send the computed set of allocation options for LB of the workflow to the first instance,
enabling the first instance to decide, based on considering the set of allocation options, a next, a second service instance in the chain of service instances, for the LB, and to send to the decided second service instance, the obtained set of allocation options; and
enabling the second service instance at a step of executing the workflow to consider the set of allocation options for deciding a next, a third service instance for the LB, and to forward the set of allocation options to the decided third service instance, to enable the third service instance at a step of executing the workflow, to consider the set of allocation options, for deciding if any remains, a further next fourth service instance for the LB.

27. The scheduler according to claim 26, wherein the set of allocation options for LB comprises a stack of textual expressions, where each textual expression comprises a reference identifying the respective associated service instance out of the chain of service instances, to consider for the LB the decision at the appropriate step of the workflow execution.

28. The scheduler according to claim 26, wherein any one out of;
each allocation option in the set of allocation options further is adapted to comprise a value defining a strength of recommending the particular service instance; or
each textual expressions in the stack of textual expressions, further comprises a value defining a strength of recommending the particular service instance.
